(19) United States
(12) Patent Application Publication
(10) Pub. No.: US 2017/0336925 A1
(43) Pub. Date: Nov. 23, 2017

(54) COMMUNICATION METHOD AND ELECTRONIC DEVICE USING THE SAME

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventor: JENG-LI HUANG, New Taipei (TW)

(21) Appl. No.: 15/252,232

(22) Filed: Aug. 31, 2016

(30) Foreign Application Priority Data
May 19, 2016 (TW) 105115478

(51) Int. Cl. G06F 3/0482; G06F 3/0484; G06F 3/0481

(52) U.S. Cl. CPC G06F 3/0482; G06F 3/04817; G06F 3/04842

(57) ABSTRACT

A method for an electronic device to establish a communication with another by reference to a selected face on a connected display screen includes the selection of faces in a photo within a number of closed paths. Photos are stored in a connected memory device, if the stored photos correspond to the selected faces the user may trigger the display of a predetermined number of icons of communication programs on the display screen. When one of the icons is triggered, a search is made for communication or contact information corresponding to the selected face, and a communication connection is established therewith.

### CROSS-REFERENCE TO RELATED APPLICATIONS

This application claims priority to Taiwanese Patent Application No. 105115478 filed on May 19, 2016, the contents of which are incorporated by reference herein.

### FIELD

The subject matter herein generally relates to communication technologies, and particularly to a communication method for establishing communication connection using an electronic device.

### BACKGROUND

An electronic device such as a mobile phone can make calls. At present, if a user does not dial a phone number via recent calls, he needs to search friends through a contact list.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is block diagrams of one embodiment of an electronic device in accordance with the present disclosure.

FIG. 2 is a block diagram of one embodiment of modules of a communication system of the electronic device in accordance with the present disclosure.

FIG. 3A and FIG. 3B illustrate closed paths circling faces on a photo but the circles are not overlapping.

FIG. 4A and FIG. 4B illustrate closed paths circling faces on a photo and the circles are overlapping.

FIG. 5 illustrates a flowchart of one embodiment of a communication method for the electronic device of FIG. 1 to establish communication.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

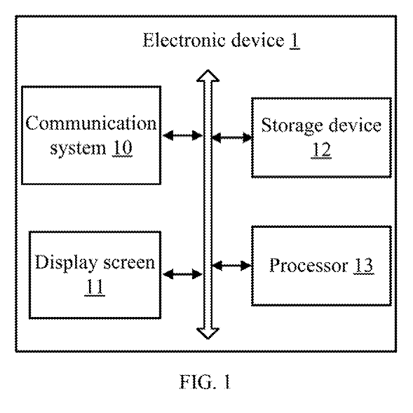

FIG. 1 is a block diagram of one embodiment of an electronic device.

Depending on the embodiment, the electronic device 1 can include, but is not limited to, a display screen 11, a storage device 12, and at least one processor 13. The above components communicate with each other through a system bus. In at least one embodiment, the electronic device 1 can be a mobile phone, a tablet computer, a personal digital assistant, or any other suitable device. FIG. 1 illustrates only one example of the electronic device 1 that can include more or fewer components than illustrated, or have a different configuration of the various components in other embodiments.

In at least one embodiment, the display screen 11 can be a liquid crystal display (LCD) or an organic light-emitting diode (OLED) display screen.

In at least one embodiment, the electronic device 1 can be electronically connected to a display device. The display device can be a television or a display. The electronic device 1 further can include an input device. The input device may receive input of the user, for example, the user may select a photo corresponding to a phone number that the user wants to dial. The input device can be a mechanical key or a touch panel on the display screen 11.

In at least one embodiment, the storage device 12 can be a memory of the electronic device 1. In other embodiments, the storage device 12 can be a secure digital card, or other external storage device such as a smart media card. In at least one embodiment, the storage device 12 can store a number of photos each of which includes at least one face, and feature values of the at least one face in the number of photos. In at least one embodiment, the storage device 12 further can store communication or contact information corresponding to each face in the number of photos. In at least one embodiment, the communication information can include, but is not limited to, an e-mail address, a social network account, a phone number, and a contact name stored in a contact list of the electronic device 1.

In at least one embodiment, the storage device 12 further can store a communication system 10. The communication system 10 can establish communication connection through communication information corresponding to faces.

The at least one processor 13 can be a central processing unit (CPU), a microprocessor, or other data processor chip that performs functions of the electronic device 1.

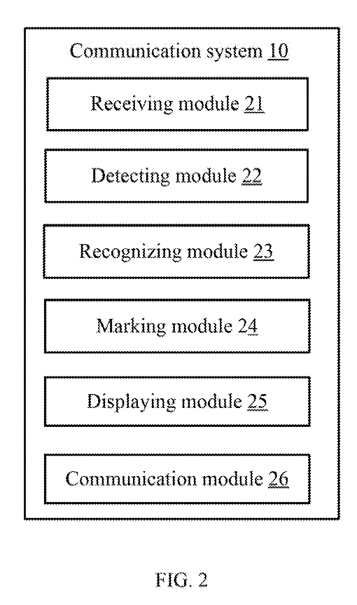

FIG. 2 is a block diagram of one embodiment of modules of a communication system of the electronic device 1. In at least one embodiment, the communication system 10 can include a receiving module 21, a detecting module 22, a recognizing module 23, a marking module 24, a displaying module 25, and a communication module 26. The modules 21-26 include computerized codes in the form of one or more programs that may be stored in the storage device 12. The computerized codes include instructions that are executed by the at least one processor 13.

In at least one embodiment, the receiving module 21 can generate a closed path to circle the at least one face in a photo after detecting a predetermined input by a user, and then one or more of the at least one face is selected. In at least one embodiment, the receiving module 21 can generate a number of closed paths, and the number of closed paths which circle the at least one face in the photo can overlap. The predetermined user input includes, but is not limited to, inputting a circular sliding operation on the display screen 11 to input a circle.

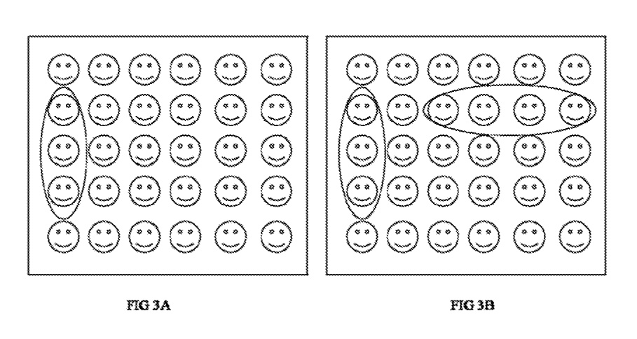

In at least one embodiment, when the number of closed paths round the at least one face in the photo do not overlap, the one or more of the at least one face circled in the number of closed paths can be selected by the receiving module 21. For example, as shown in FIG. 3A, there is one closed path drawn in a photo, and there are three faces circled in the closed path. Thus, the three faces in the photo are regarded as faces selected by the user. As shown in FIG. 3B, there are two closed paths in the photo, and there are three faces circled in one closed path, and there are four faces circled in the other closed path. Thus, seven faces in the photo are regarded as faces selected by the user.

In at least one embodiment, when there is an overlap by the number of closed paths which is circling the at least one face in the photo, the receiving module 21 selects one or more of the at least one face which is circled with an odd number of times. That is, the one or more face which is repeatedly circled by closed paths for an odd number of times is regarded as face selected by the user. When the number of closed paths circle the at least one face in the photo more than once, the one or more face which is repeatedly circled for an even number of times is not regarded as selected face by the receiving module 21.

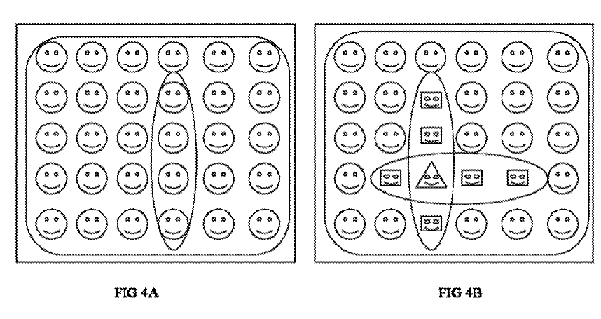

For example, as shown in FIG. 4A, there are two closed paths, a large first closed path which circles thirty faces in the photo, and a smaller second closed path which circles four of the thirty faces in the photo. That is, the four faces circled in the second closed path are repeatedly circled (that is, the first and second closed paths are overlapping over the four faces). Thus, the four faces circled twice cannot be selected by the receiving module 21. The other faces circled once (that is, the other twenty six faces) can be selected by the receiving module 21. As shown in FIG. 4B, there are three closed paths, one large and two smaller ones. There are six faces circled twice (e.g., rectangle faces in FIG. 4B), one face circled three times (e.g., triangle face in FIG. 4B), and the other faces in the photo circled only once (e.g., round faces in FIG. 4B). Thus, the six faces circled twice cannot be selected by the receiving module 21, but the faces circled an odd number of times, (e.g., one and three times), can be selected by the receiving module 21.

In at least one embodiment, the detecting module 22 can detect the one or more selected face in the photo by extracting feature values of the one or more selected face. In at least one embodiment, the detecting module 22 can detect the one or more selected face in the photo by face recognition technology.

In at least one embodiment, the recognizing module 23 can determine whether the storage device 12 stores photos having the one or more selected face. As mentioned above, the storage device 12 stores feature values of the at least one face in the number of photos. The recognizing module 23 can detect whether the storage device 12 stores the photos having the one or more selected face by comparing the feature values of the one or more selected face with the feature values of the at least one face in the number of photos. When the feature values of the one or more selected face exist in the storage device 12, it is determined that the storage device 12 stores the photos having the one or more selected face. When the feature values of the one or more selected face do not exist in the storage device 12, it is determined that the storage device 12 does not store the photos having the one or more selected face.

In at least one embodiment, the marking module 24 can mark the one or more selected face. In at least one embodiment, the face marking can be a shape such as a polygon, for example, or a rectangle. The face marking can appear on the one or more selected face, and can be displayed with predetermined colors.

In at least one embodiment, the displaying module 25 can display a predetermined number of communication icons on the display screen 11 after the face marking is triggered by the user. In at least one embodiment, the communication icons include, but are not limited to, a phone program icon, a text message program icon, and an e-mail program icon. The communication icons can be displayed next to the face marking, or can be displayed on a new interface that is generated by the display screen 11.

In at least one embodiment, the communication module 26 can search for communication or contact information corresponding to the one or more selected face after one of the predetermined number of communication icons is triggered, and establish a communication connection thereto. For example, the communication module 26 can search for a phone number corresponding to the one or more selected face after the phone program icon of the one or more selected face is clicked, and dial the phone number to establish a communication connection.

In at least one embodiment, the communication module 26 can record the number of times that a communication connection to each face on the photo is made, and select one face that is recorded the greatest number of times. When the user is looking at the photo having the one or more selected face, the communication module 26 can display the communication icon beside the one or more face without activating the face marking or other prompt. It is thus convenient for the user to establish a communication connection with the one or more face in the photo.

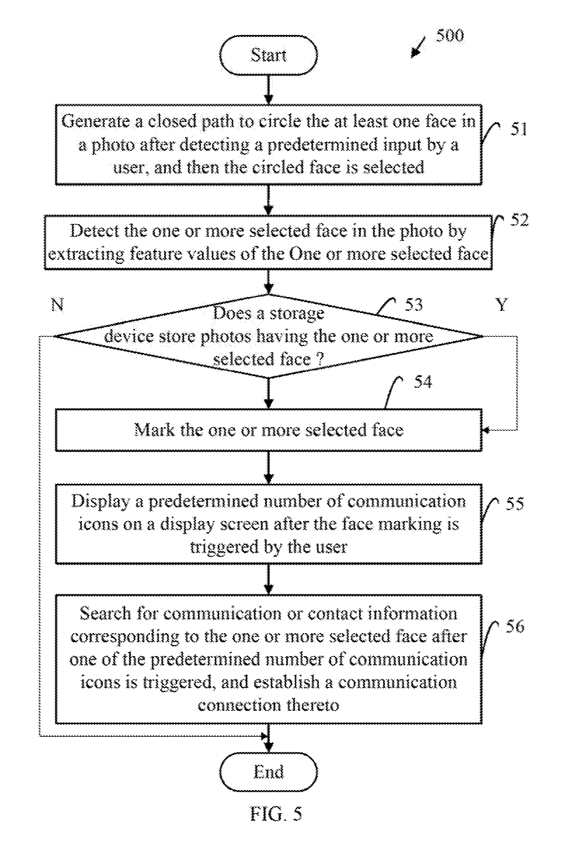

FIG. 5 illustrates a flowchart which is presented in accordance with an example embodiment. The example method 500 is provided by way of example, as there are a variety of ways to carry out the method. The method 500 described below can be carried out using the configurations illustrated in FIG. 1, for example, and various elements of these figures are referenced in explaining example method 500. Each block shown in FIG. 5 represents one or more processes, methods, or subroutines, carried out in the example method 500. Additionally, the illustrated order of blocks is by example only and the order of the blocks can be changed according to the present disclosure. The example method 500 can begin at block 51. Depending on the embodiment, additional steps can be added, others removed, and the ordering of the steps can be changed.

At block 51, the receiving module 21 can generate a closed path to circle the at least one face in a photo after detecting a predetermined input by a user, and then one or more of the at least one face is selected. In at least one embodiment, the receiving module 21 can generate a number of closed paths, and the number of closed paths which circle the at least one face in the photo can overlap. The predetermined user input includes, but is not limited to, inputting a circular sliding operation on the display screen 11 to input a circle.

In at least one embodiment, when the number of closed paths round the at least one face in the photo do not overlap, the one or more of the at least one face circled in the number of closed paths can be selected by the receiving module 21. For example, as shown in FIG. 3A, there is one closed path drawn in a photo, and there are three faces circled in the closed path. Thus, the three faces in the photo are regarded as faces selected by the user. As shown in FIG. 3B, there are two closed paths in the photo, and there are three faces circled in one closed path, and there are four faces circled in the other closed path. Thus, seven faces in the photo are regarded as faces selected by the user.

In at least one embodiment, when there is an overlap by the number of closed paths which is circling the at least one face in the photo, the receiving module 21 selects one or more of the at least one face which is circled with an odd number of times. That is, the one or more face which is repeatedly circled by closed paths for an odd number of times is regarded as face selected by the user. When the number of closed paths circle the at least one face in the photo more than once, the one or more face which is repeatedly circled for an even number of times is not regarded as selected face by the receiving module 21.

For example, as shown in FIG. 4A, there are two closed paths, a large first closed path which circles thirty faces in the photo, and a smaller second closed path which circles four of the thirty faces in the photo. That is, the four faces circled in the second closed path are repeatedly circled (that is, the first and second closed paths are overlapping over the four faces). Thus, the four faces circled twice cannot be selected by the receiving module 21. The other faces circled once (that is, the other twenty six faces) can be selected by the receiving module 21. As shown in FIG. 4B, there are three closed paths, one large and two smaller ones. There are six faces circled twice (e.g., rectangle faces in FIG. 4B), one face circled three times (e.g., triangle face in FIG. 4B), and the other faces in the photo circled only once (e.g., round faces in FIG. 4B). Thus, the six faces circled twice cannot be selected by the receiving module 21, but the faces circled an odd number of times, (e.g., one and three times), can be selected by the receiving module 21.

At block 52, the detecting module 22 can detect the one or more selected face in the photo by extracting feature values of the one or more selected face. In at least one embodiment, the detecting module 22 can detect the one or more selected face in the photo by face recognition technology.

At block 53, the recognizing module 23 can determine whether the storage device 12 stores photos having the one or more selected face. As mentioned above, the storage device 12 stores feature values of the at least one face in the number of photos. The recognizing module 23 can detect whether the storage device 12 stores the photos having the one or more selected face by comparing the feature values of the one or more selected face with the feature values of the at least one face in the number of photos.

When the feature values of the one or more selected face exist in the storage device 12, it is determined that the storage device 12 stores the photos having the one or more selected face. When the feature values of the one or more selected face do not exist in the storage device 12, it is determined that the storage device 12 does not store the photos having the one or more selected face.

At block 54, the marking module 24 can mark the one or more selected face. In at least one embodiment, the face marking can be a shape such as a polygon, for example, or a rectangle. The face marking can appear on the one or more selected face, and can be displayed with predetermined colors.

At block 55, the displaying module 25 can display a predetermined number of communication icons on the display screen 11 after the face marking is triggered by the user. In at least one embodiment, the communication icons include, but are not limited to, a phone program icon, a text message program icon, and an e-mail program icon. The communication icons can be displayed next to the face marking, or can be displayed on a new interface that is generated by the display screen 11.

At block 56, the communication module 26 can search for communication or contact information corresponding to the one or more selected face after one of the predetermined number of communication icons is triggered, and establish a communication connection thereto. For example, the communication module 26 can search for a phone number corresponding to the one or more selected face after the phone program icon of the one or more selected face is clicked, and dial the phone number to establish a communication connection.

In at least one embodiment, the communication module 26 can record the number of times that a communication connection to each face on the photo is made, and select one face that is recorded the greatest number of times. When the user is looking at the photo having the one or more selected face, the communication module 26 can display the communication icon beside the one or more face without activating the face marking or other prompt. It is thus convenient for the user to establish a communication connection with the one or more face in the photo.

The block 54 can be omitted, and at block 55, the displaying module 25 can display a predetermined number of communication icons on the display screen 11 after the selected faces is triggered by the user.

In other embodiments, a receiving module 21, a detecting module 22, a recognizing module 23, a marking module 24, a displaying module 25, and a communication module 26 of the communication system 10 can be hardware or firmware.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A communication method applied in an electronic device, the electronic device comprising a storage device that stores a plurality of photos each of which comprises at least one face, and feature values of the at least one face in the plurality of photos, the method comprising:
generating a plurality of closed paths to circle the at least one face in a photo;
selecting one or more of the at least one face;
detecting the one or more selected face in the photo by extracting feature values of the one or more selected face;
determining whether the storage device stores photos having the one or more selected face;
displaying a predetermined number of communication icons on a display screen of the electronic device when the storage device stores photos having the one or more selected face and the one or more selected face is triggered;
searching for communication information corresponding to the one or more triggered face after one of the predetermined number of communication icons of the one or more selected face is triggered; and
establishing a communication connection through the searched communication information.

2. The method according to claim 1, further comprising:
marking the one or more selected face when photos stored in the storage device having the one or more selected face.

3. The method according to claim 1, wherein the step of selecting the one or more circled face comprises:
selecting the one or more face which is circled in the plurality of closed paths when the plurality of closed paths round the at least one face in the photo do not overlap; and
selecting the one or more face which is circled in the plurality of closed paths in an odd number of times when the plurality of closed paths round the at least one face in the photo overlapped.

4. The method according to claim 1, wherein the step of determining whether the storage device stores photos having the one or more selected face comprises determining whether the storage device stores the photos having the one or more selected face by comparing the feature values of the one or more selected face with the feature values of at least one face in the photos stored in the storage device.

5. The method according to claim 1, wherein the communication information comprises: an e-mail address, a social network account, a phone number, and a contact name stored in a contact list of the electronic device.

6. An electronic device comprising:
a storage device that stores a plurality of photos each of which comprises at least one face, and feature values of the at least one face in the plurality of photos;
at least one processor; and
the storage device further stores one or more programs that, when executed by the at least one processor, cause the at least one processor to:
generate a plurality of closed paths to circle the at least one face in a photo;
select one or more of the at least one face;
detect the one or more selected face in the photo by extracting feature values of the one or more selected face;
determine whether the storage device stores photos having the one or more selected face;
display a predetermined number of communication icons on a display screen of the electronic device when the storage device stores photos having the one or more selected face and the one or more selected face is triggered;
search for communication information corresponding to the one or more triggered face after one of the predetermined number of communication icons of the one or more selected face is triggered; and
establish a communication connection through the searched communication information.

7. The electronic device according to claim 6, wherein the at least one processor further caused to:
mark the one or more selected face when photos stored in the storage device having the one or more selected face.

8. The electronic device according to claim 6, wherein the step of selecting the one or more circled face comprises:
selecting the one or more face which is circled in the plurality of closed paths when the plurality of closed paths round the at least one face in the photo do not overlap; and
selecting the one or more face which is circled in the plurality of closed paths in an odd number of times when the plurality of closed paths round the at least one face in the photo overlapped.

9. The electronic device according to claim 6, wherein the step of determining whether the storage device stores photos having the one or more selected face comprises determining whether the storage device stores the photos having the one or more selected face by comparing the feature values of the one or more selected face with the feature values of at least one face in the photos stored in the storage device.

10. The electronic device according to claim 6, wherein the communication information comprises: an e-mail address, a social network account, a phone number, and a contact name stored in a contact list of the electronic device.

11. A non-transitory storage medium having stored thereon instructions that, when executed by a processor of an electronic device, causes the processor to perform a method for establishing communication connection, the electronic device comprising a storage device that stores a plurality of photos each of which comprises at least one face, and feature values of the at least one face in the plurality of photos, wherein the method comprises:
generating a plurality of closed paths to circle the at least one face in a photo;
selecting one or more of the at least one face;
detecting the one or more selected face in the photo by extracting feature values of the one or more selected face;
determining whether the storage device stores photos having the one or more selected face;
displaying a predetermined number of communication icons on a display screen of the electronic device when the storage device stores photos having the one or more selected face and the one or more selected face is triggered;
searching for communication information corresponding to the one or more triggered face after one of the predetermined number of communication icons of the one or more selected face is triggered; and
establishing a communication connection through the searched communication information.

12. The non-transitory storage medium according to claim 11, further comprising:
marking the one or more selected face when photos stored in the storage device having the one or more selected face.

13. The non-transitory storage medium according to claim 11, wherein the step of selecting the one or more circled face comprises:
selecting the one or more face which is circled in the plurality of closed paths when the plurality of closed paths round the at least one face in the photo do not overlap; and
selecting the one or more face which is circled in the plurality of closed paths in an odd number of times when the plurality of closed paths round the at least one face in the photo overlapped.

14. The non-transitory storage medium according to claim 11, wherein the step of determining whether the storage device stores photos having the one or more selected face comprises determining whether the storage device stores the photos having the one or more selected face by comparing the feature values of the one or more selected face with the feature values of at least one face in the photos stored in the storage device.

15. The non-transitory storage medium according to claim 11, wherein the communication information comprises: an e-mail address, a social network account, a phone number, and a contact name stored in a contact list of the electronic device.
